(19) United States
(12) Patent Application Publication
(10) Pub. No.: US 2006/0022414 A1
(43) Pub. Date: Feb. 2, 2006

(54) Rotary cartridge seals with composite retainer

(76) Inventor: Peter J. Balsells, Newport Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 10/903,333

(22) Filed: Jul. 30, 2004

(51) Int. Cl. F16J 15/32

(52) U.S. Cl. 277/572

(57) ABSTRACT

In a rotary cartridge seal having a plastic ring with a body for sealably engaging a housing bore and a lip for sealably engaging a shaft rotatable within the housing bore and an internal groove in the body for engaging the ring in order to latch the plastic ring and a retainer together with residual stress in both axial and radial direction within the plastic ring due to the groove and ring dimensions and shape, an improvement wherein the retainer is a composite retainer for fixing the plastic ring within the housing bore and around the shaft. The composite retainer has a surface of revolution with a rear portion having a radius suitable for press fitting into the housing bore and a front portion of lesser radius ending in a ring. The composite retainer is made from a material having a modulus of elasticity at least double the sealing ring material and maintains a retention force sufficient to prevent seal separation upon application of pressure and temperature differential. The retainer ring can be machined or molded from a composite material.

The present invention generally relates to cartridge rotary seals that are pressed into a housing and provide a seal around a shaft at relatively low pressures under various fluid environments. More particularly, the present invention is directed to cartridge seals utilizing a preferably flowable plastic sealing ring and a separate composite retaining ring having a higher modulus of elasticity.

Cartridge rotary seals have been used for many years in a variety of applications for the sealing of various types of fluids and gases. Generally these seals have employed various elastomers, which are bonded to the metal. This application utilizes various types of plastics and fluoropolymers. For example, polytetrafluoroethylene, PTFE, is used because it exhibits relatively low friction, is chemically inert, and can withstand a variety of temperatures, thus enabling its use under conditions with no lubrication.

Such prior art cartridge seals utilized the elastomer in a bonded relationship with a circular metallic ring, which often is U-shaped. The metallic portion of the seal is pressed into a housing while the elastomeric seal bears around the shaft.

As hereinabove noted, when plastics are utilized, such as fluoropolymers, the plastic is mechanically retained to the metallic ring and the entire assembly is pressed into the housing with a degree of interference between the OD of the seal and the housing to permit retention of the seal assembly into the housing at the same time providing static sealing against the housing. Dynamic sealing between the seal and the shaft is provided by the contact between the plastic and the shaft. For purposes of this definition: Composite material may also be a single plastic material with no other materials.

The present invention eliminates the need for a metal ring and provides for a rotary cartridge seal including a separate plastic ring and a composite retainer which are uniquely locked together in order to provide a residual force therebetween to maintain the components together within specific pressure and temperature parameters.

This arrangement enables the reduction of insertion force required to insert a rotary cartridge seal into a housing as will as provide more consistent performance under some temperature-pressure conditions and importantly, reduce fabrication costs.

### SUMMARY OF THE INVENTION

A rotary cartridge seal in accordance with the present invention generally includes a cold flowable plastic ring having a body for sealably engaging a housing bore and a lip for sealably engaging a shaft rotating within the housing bore. Importantly, as hereinafter discussed in greater detail, the usable plastic material is preferably cold flowable, such as, for example, polytetrafluoroethylene, PTFE and compositions of PTFE and UHMW (ultra high molecular weight polyethylene). The use of these materials enable an appropriate cold flowable plastic to maintain radial and axial stability of the plastic ring between the housing and the shaft. Other materials, hereinafter identified, may also be suitable.

A separable composite retainer provides means for fixing the plastic ring within the housing bore and around the shaft. The separable composite retainer includes a surface of revolution with a rear portion having a diameter suitable for press fitting into the housing bore and a front portion of lesser diameter ending in a ring. The retainer is formed from a composite material that can be easily machined or molded to reduce fabrication costs.

An internal groove is provided in the plastic ring body for engaging the composite ring therein in order to latch the plastic ring and composite ring together with a residual stress in a radial direction in the plastic ring body. This residual stress is created and maintained by specific configuration of the retainer. Alternatively, the composite retainer may include a spring portion for providing the radial stress.

### BRIEF DESCRIPTION OF THE DRAWINGS

The advantages and features of the present invention would be better understood by the following description when considered in conjunction with the accompanying drawings, in which:

FIG. 1 is a cross sectional view of one embodiment of the present invention showing a rotary cartridge seal disposed between a housing and a shaft with the seal generally including a plastic ring with a separable composite retainer for fixing the plastic ring within the housing and around the shaft;

FIG. 2 is an enlarged cross sectional view of a portion of the embodiment shown in FIG. 1 showing greater detail of the engagement between the non-metallic retainer and the plastic ring;

FIG. 3 is a cross sectional view of yet another embodiment of the present invention in which a spring is disposed in a position for biasing a lip of the plastic ring against a shaft and a composite retainer includes a step for facilitating separation of the composite retainer from the housing bore;

FIG. 4 is another embodiment of the present invention similar to that shown in FIG. 1, but with the plastic ring having a lip thereon with an enlarged head portion;

FIG. 5 is a cross sectional view of yet another embodiment of the present invention in which the plastic ring includes a thin forward portion and radial stress, as hereinafter discussed in greater detail, is provided by an extended or cantilever portion of the composite ring;

FIG. 6 is an enlarged cross sectional view taken along the line 6-6 of FIG. 5 showing a groove and dovetail arrangement for facilitating cold flow of plastic material;

FIG. 7 is a cross sectional view of another embodiment of the present invention illustrating the application of radial stress in the plastic ring;

FIG. 8 is a cross sectional view of yet another embodiment of the present invention showing a ring portion in the composite retainer having a generally arrow shaped cross section;

FIG. 9 is a view taken along the line 9-9 of FIG. 7 showing longitudinal slots in the composite retainer;

FIG. 10 is a view taken along the line 10-10 of FIG. 8 showing flat portions on a forward portion of the plastic ring to prevent rotation thereof within the housing;

FIG. 11 is yet another embodiment of the present invention illustrating the use of a spring disposed within the plastic ring for biasing the lip and bearing against the composite retainer;

FIG. 12 is another illustration of the embodiment shown in FIG. 11 showing its ability to be disposed between the housing and the shaft in a reversed direction;

FIG. 13 is a cross sectional view of another embodiment of the present invention showing a rotary cartridge seal, disposed between the housing and the shaft, with the seal generally including a plastic ring with separable composite retainer for fixing a plastic ring within the housing on the shaft, the composite retainer including a spring portion for controlling residual stress in a radial direction within the plastic ring and preventing shrinkage of the plastic ring toward the shaft;

FIG. 14 is a cross sectional view of another embodiment of the present invention utilizing a retainer having a depending thin wall lug for maintaining a spring within the plastic ring and for facilitating removal of the seal from between the housing and the shaft;

FIG. 15 is another embodiment of the present invention showing variations in wall thickness of the retainer;

FIG. 16A-16H show various configurations of the locking composite retainer that affects the force applied to the plastic ring and variations of such force;

FIG. 17A-17C show variations of the embodiment shown in FIG. 13;

FIG. 18 shows a seal design in accordance with the present invention utilized in a captivated seal gland configuration;

FIG. 19 shows the seal shown in FIG. 18 used as an uncaptivated seal gland;

FIG. 20 shows an embodiment of the present invention utilizing a garter-type spring loading a lip off the plastic ring;

FIG. 21 shows another embodiment of the present invention utilizing a plastic ring with a memory lip;

FIG. 22 shows another embodiment of the present invention in which the plastic ring is utilized to provide a clearance seal against a shaft primarily for keeping dust and dirt out;

FIG. 23 is a variation of the embodiment shown in FIG. 22;

FIG. 24 is an embodiment including the features of FIGS. 21 and 22;

FIG. 25 is a variation of the design shown in FIG. 24 when two seals are assembled back to back;

FIG. 26 shows yet another embodiment of the present invention in which the non-metallic retainer ring is pressed into the housing holding a plastic ring seal utilizing two memory lips;

FIG. 27 is a variation of the embodiment shown in FIG. 13 in which an inside diameter of the retainer has been made slightly larger than the shaft diameter;

FIG. 28 is another embodiment of the present invention in which the retainer ring provides a labyrinth seal at the ID thereof, the retainer being made of a composite material in order to reduce insertion force yet provide sufficient force to retain the seal and housing and not damage the shaft;

FIG. 29 is another embodiment of the present invention utilizing a V-type, or finger-type spring;

FIG. 30 is yet another embodiment of the present invention utilizing a back-up ring;

FIG. 31 shows another embodiment of the present invention utilizing two seals of the same design placed end to end;

FIG. 32 is an embodiment similar to FIG. 31 in which the relative placement of the seals is reversed;

FIG. 33 shows another embodiment of the present invention in which a garter-type is used to apply an extension spring force on the seal onto the shaft for high speed applications along with a secondary memory type seal to prevent contaminants from coming the direction opposite the pressure applied;

FIG. 34 is yet another embodiment of the present invention in which the seal is mounted on the shaft instead of the housing; and

FIG. 35 through 68 are additional embodiments of the present invention.

### DETAILED DESCRIPTION

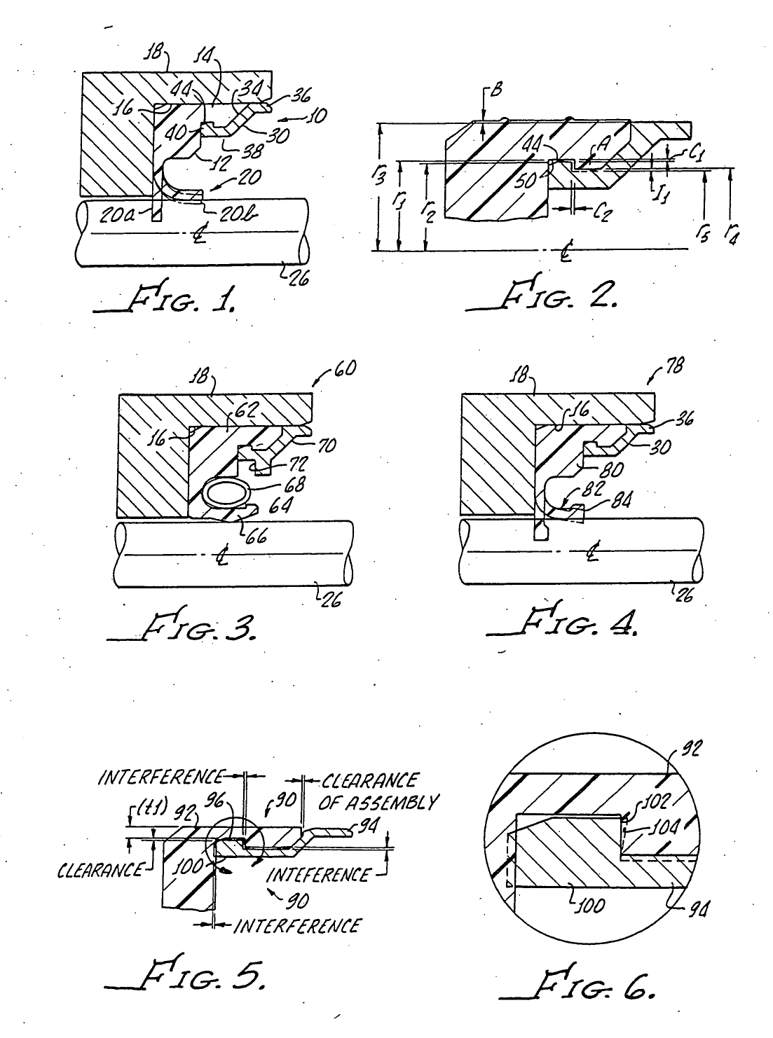

Turning now to FIG. 1 there is shown a rotary cartridge seal 10 in accordance with the present invention which generally includes a cold flowable plastic ring 12 having a body 14 which provides means for sealably engaging a housing bore 16, formed in a housing 18, and a lip 20 which provides means for sealably engaging a shaft 26. In FIG. 1 the lip 20 is shown in dashed line 20a in a position before seal 10 is inserted between the housing 18 and shaft 26 and the dashed line 20b represents an effective range of sealing for the lip 20.

The present invention preferably utilizes a cold flowable plastic material, such as PTFE, PTFE compositions with various fillers or UHMW to enable the flow of the material when properly stressed, in accordance with the present invention. However, other suitable materials are to be considered within the scope of the present invention. For example, there are certain thermo plastic materials designed to operate at high temperature that become flowable at elevated temperatures that are suitable. Although such materials do not make good seals at normal temperatures, they do make suitable seals at temperatures beginning at 250° F. on up to 600° F. Such materials may be PEEK, polyetherether ketone and derivatives of such materials and are generally indicated as high performance polymer materials.

In fact, the residual stress maintains the plastic ring in intimate contact with a separate composite retainer 30 in a manner which creates residual stress for maintaining the components together within specific temperature parameters.

No permanent bonding occurs between the plastic ring 12 and the composite retainer 30, with the latter providing a means for retaining the plastic ring within the housing bore 16 and around the shaft 26. As shown, the separable composite retainer 30 includes a surface of revolution 34 having a rear portion 36 with a diameter suitable for press fitting into the housing bore 16 and a front portion 38 having a lesser diameter which ends in a ring 40. The ring 12 and composite retainer 30 have the advantage of being moldable, thus reducing fabrication costs. In addition, such materials have a lower modulus of elasticity that requires less force to assemble the locking ring into the housing—a disadvantage when using metal locking rings.

An internal groove 44 within the retaining plastic ring body 14, as more clearly shown in FIG. 2, has a radius r₁ greater than a ring radius r₂, resulting in a clearance C₁. Such clearance facilitates assembly of the retainer into the plastic groove. The ring front portion 38 adjacent the ring 40 has an outside radius less than a contacted inside radius of the plastic ring body 14 indicated as interference I₇, in order to maintain the radial stress in the plastic ring body 14.

In addition, a width of the groove 44 is greater than a width of the ring as indicated by the clearance C₂. Such clearance facilitates assembly of the two parts. However, upon insertion of the seal 10, between the housing 18 and the seal O.D. 12, causes cold flow of the PTFE into the groove 44 and around the ring 40 creating an axial stress in the plastic ring 12. This deformation force can be applied radially, axially or a combination of radial and axial forces with the purpose of providing locking action between the plastic ring 12 and the composite retainer 30.

Depending upon the wall thickness of the plastic ring 12, additional radial loading may be provided by the composite retainer 30 so as to exert added axial spring-like force to maintain greater and longer intimate contact between the plastic ring 12 and the housing 18. As hereinafter described in greater detail with regard to other embodiments of the present invention, seals in accordance with the present invention provide sealing throughout a greater temperature range. The composite retainer 30 may be designed to add flexibility and increase the loading force as the temperature increases and the bearing stress of the PTFE decreases. In this manner, a spring force provided by the composite retainer 30 maintains an improved sealing ability of the cartridge seal 10 while maintaining contact between the seal OD and the housing 18.

The groove 44 in the plastic ring body 14 and the ring 40 portion of the composite retainer 30 is assembled as a rotary cartridge seal 10 by forcing the composite retainer 30 into the plastic ring 12 which expands the plastic ring 12 radially and causes the plastic ring 12 to “snap” which creates a diametrical interference between the ID of the plastic ring 12 and the OD of the non-metallic retainer 30 at the area A so that a residual circular stress remains.

In this instance, “snap” refers to the radial and/or axial expansion of the plastic which allows plastic to return to its normal position but creates a radial or axial residual stress around the expanded surfaces.

Upon assembly of the plastic ring 12 and composite retainer 30 into the housing bore 16 and over the shaft 26 causes a diametrical force, as hereinabove noted, to be applied on the plastic ring 12. Interference between the OD of the plastic ring 12 and the housing bore 16 provides a radial load on the plastic ring 12 for maintaining intimate contact between the OD of an area A of the composite retainer 30 and the plastic ring 12.

Inasmuch as this interference adds to stress, which is maintained between the two surfaces, the composite retainer 30 and plastic ring 12 are locked both axially and radially. Excess plastic flows around the outside radius r₃ of the plastic seal which creates an interference with the housing indicated at B in FIG. 2. In addition, this cold flow, enabled through the use of PTFE, causes filling of the clearance C₂ and gap between the ring 40 and the groove 44 to provide axial stress and positive latching or locking of the non-metallic retainer 30 and the plastic ring 12. Naturally, in this regard, proper spring-like composite retainer 30 material must be utilized, such as, for example polyetherether ketone or carbon filled polyetherether ketone.

It should be appreciated that the plastic ring 12 and the composite retainer 30 may be locked in place by either an axial locking action, a radial locking action or a combination of both. That is, there may be axial clearance at assembly, which may or may not be filled by the cold flowing of the material, as in C₂, FIG. 2, or radial clearance at assembly as in C₁ and such clearance may remain or may not remain after the cold flow of the material. But in all cases, there will be some sort of residual induced stress, be axial, radial, or a combination of axial and radial.

More specifically, and by way of example only, the plastic PTFE ring may have an outside radius of between about 19.000 mm and about 19.126 mm with a housing having a radius between about 19.063 mm and about 19.037 vacating a radial interference ranging between about 0.089 mm-0.0035″ to about 0.063 mm-0.024″.

The plastic ring groove may have a radius of r₁, between about 17.907 mm and about 17.882 mm with a non-metallic ring groove diameter r₂ of between about 17.832 mm and about 17.356 mm having a radial clearance between about 0.000 mm to about 0.051 mm.

The plastic ring groove radius rs may have a radius of between about 17.526 mm and about 17.500 mm with a non-metallic ring radius r₄ of between about 17.597 mm and about 17.551 mm having a radial interference between about 0.092 mm to about 0.025 mm.

In addition, the difference between the groove 44 width and ring 40 width may provide for clearance C₂ of between about 0.000 mm and about 0.051 mm.

This configuration enables sealing between the housing 18 and the shaft 26 at temperatures between about −20° C. and about 100° C. at shaft rotational speeds of up to 5000 RPM, when using PTFE compositions, as for example, containing 20% carbon, 5% graphite, 78% PTFE.

Another embodiment 60 in accordance with the present invention is shown in FIG. 3 in which plastic ring 62 includes a second groove 64 adjacent a lip 66 is provided for receiving a spring 68 for biasing the lip 66 against the shaft 26.

In addition, a composite retainer 70 which is similar in design to the retainer 30 but which includes an inwardly extending step 72 which provides means for facilitating separation of the composite retainer 70 from the housing bore 16 along with the plastic ring 62.

A further embodiment 78 of the present invention is shown in FIG. 4 in which common character references refer to identical or substantially the same elements shown in FIG. 1. In this embodiment 78, a plastic ring 80 includes a lip portion 82 having a head 84 thereof which provides a means for contacting the shaft 26 over a greater area.

Turning now to FIG. 5, yet another embodiment 90 in accordance with the present invention includes a plastic ring 92 and a composite retainer 94. In this instance, the plastic ring 92 includes a relatively thin wall thickness t₁, and accordingly, no radial snapping action occurs due to the flexibility of the plastic ring 92 at that point. However, snapping action occurs axially as hereinabove described in accordance with the embodiments shown in FIGS. 1-4.

In the rotary cartridge seal embodiment 90 shown in FIG. 5, the ID of the plastic ring 92 expands radially during assembly which allows partial entry of the composite retainer 94 into the plastic ring groove 96. Sufficient force is applied axially which causes axial deformation of the plastic ring 92 at the groove 96, that creates an axial snap action by compressing and deforming the plastic ring 92 axially around the groove 96 area.

The axial deformation of the plastic ring 92 causes a residual stress that maintains axial as well as radial contact with the groove 96 in order to lock the plastic ring 92 in the non-metallic retainer 94 together. This configuration adds to reliability and ability of the seal 90 at high temperatures through the combined axial and radial residual stresses that remain the in plastic ring 92.

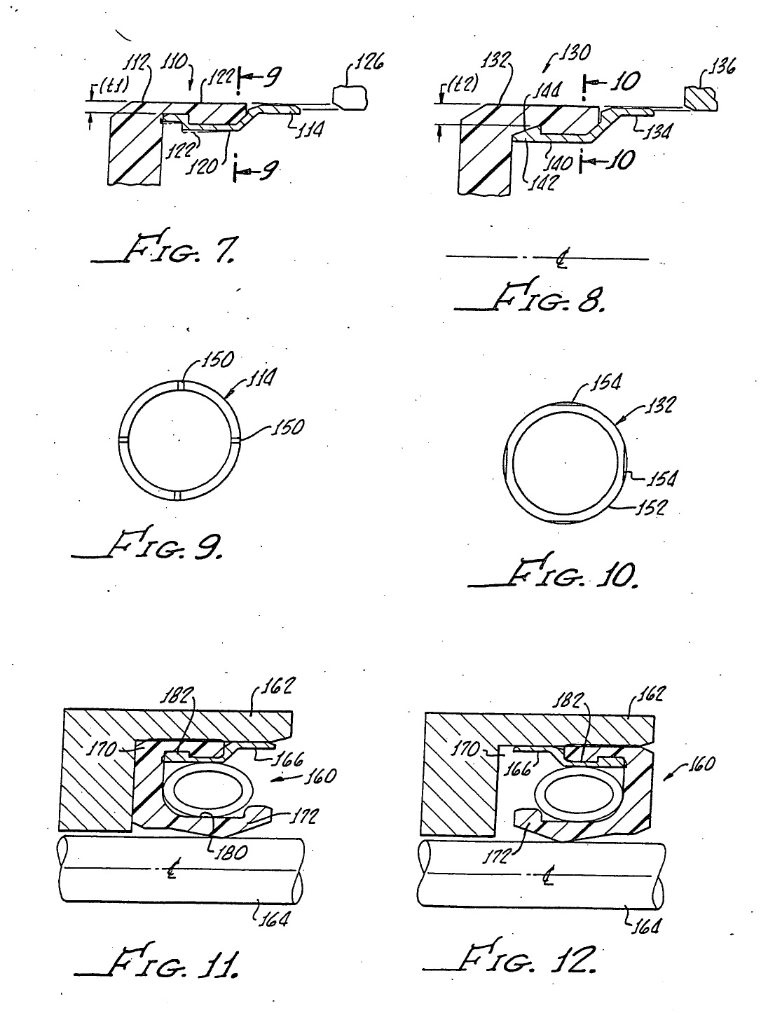

The groove ring 100 on the composite retainer 94 may be dovetailed as shown in FIG. 6, or it may be squared. A dovetailed design facilitates assembly of the composite retainer 94 into the plastic ring 92. In addition, the dovetail 102 as well as a corresponding dovetail 104 in the plastic ring 92 enables a greater amount of cold flowing of the PTFE material of the ring 92 into the area therebetween. This provides for a more substantial locking of the plastic ring 92 and the composite retainer 94.

Referring to FIG. 7, another rotary cartridge seal embodiment 110 in accordance with the present invention which is similar in design to the seal 10 hereinabove discussed in connection in FIG. 1.

A plastic ring 112 is provided as well as a composite retainer 114. However, in this instance, a composite retainer 114 is thin-walled. The composite retainer 114 includes a long cantilever front portion 120 which magnifies radial deflection thereof as indicated by the dashed line 122 in FIG. 7. This added spring deflection increases the radial load on the body portion 122 of the plastic ring 112 which provides additional force in addition to the residual force that already exists so that the seal assembly 110 can be used at higher temperature.

The circular deflection of the composite retainer 114, is sufficient to maintain intimate contact between the OD of the plastic ring 112 and the non-metallic retainer 114. It should be appreciated that the residual stress that occurs radially and axially during assembly decreases as the temperature increases. Accordingly, this added radial spring force, caused by the thin section cantilever 122, takes up such loss of residual stress at elevated temperatures and permits the seal assembly to operate at higher temperatures due to such added radial deflection. The seal assembly 110 is pressed and retained into a housing 126 by interference that occurs between the non-metallic ring OD and the housing 16.

FIG. 8 shows a further rotary cartridge seal embodiment 130 in accordance with the present invention including a plastic ring 132 and composite retainer 134 for insertion into a housing 136. A thin cantilever section 140 of the composite retainer 132 is provided with an arrowhead-shaped head 142, which is forced into intimate contact with a correspondingly shaped groove 144 to create axial locking between the plastic ring 132 and the composite retainer 134. The arrowhead 142 may have a dovetail design as shown in FIG. 6 to improve locking action. Radial interference is provided between the seal OD and the housing 136 to improve seal performance.

Improved flexibility of the cantilever portion 120 of the composite retainer 114 shown in FIG. 7 may be obtained by providing longitudinal slots 150 as shown in FIG. 9. Slots 150 provide for added deflection and hence greater flexibility of the composite retainer 114 in order to accommodate larger temperature ranges as may be desired.

Further, as shown in FIG. 10, the plastic ring 132 may include a plurality of flats 154 on a circumference 156 in order to prevent rotation of the plastic ring 132 during operation. As hereinabove noted, the cold flow characteristics of the PTFE material utilized in the ring 132 enable material to flow into the flats thereby preventing rotation of the plastic 132.

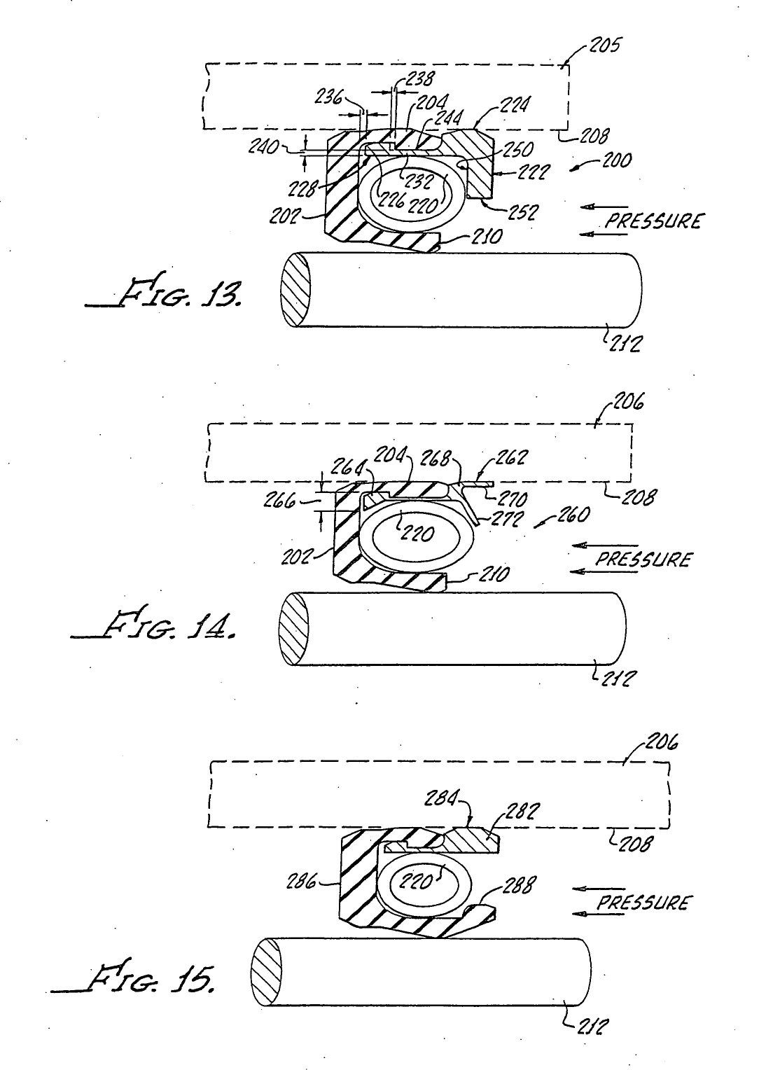

Yet another embodiment 160 of the present invention is shown in FIGS. 11 and 12. The rotary cartridge seal 160 design enables the cartridge seal 160 to be inserted and utilized between a housing 162 and shaft 164 in opposite directions as are correspondingly represented in FIGS. 11 and 12. A composite retainer 166 is similar to the retainer hereinabove described in connection with retainer 30 shown in FIG. 1, and the plastic ring 170 having a lip 172 is similar in design and function to the plastic ring 62 and lip 66 as described in connection with FIG. 3. In this instance, a plastic ring 170 is U-shaped and a spring 180 is disposed therein between a lip 172 and the composite retainer 166 with the spring 180 being disposed in the position bearing against a composite retainer front portion 182. This configuration provides for increased sealing ability.

It should be noted that sealing lip designs indicated in FIGS. 1 and 4 may be used in place of the designs indicated in FIGS. 11 and 12.

It should be appreciated that the hereinabove discussed rotary cartridge seals, 10, 60, 78, 90, 110, 130 and 160 provide for an assembly that creates residual stresses to maintain intimate contact between the plastic rings and retainers within a specific temperature ranges, for example, between about −20° and about 100° C. Intimate contact between seal surfaces take up for variations that may occur to the PTFE material during usage especially at elevated temperatures. Specifically described dimensions and configurations with regard to clearances hereinabove discussed, control the cold flow of the PTFE material, and limit the shrinkage thereof, while maintaining residual stress in order to maintain intimate contact between the plastic rings and corresponding composite retainers.

The hereinafter discussed embodiments in accordance with the present invention include means for reducing the assembly force required to assemble the seal and the housing, minimize the variation from seal to seal when assembling the seal into the housing and utilizing a spring for providing bias between a plastic ring seal and a shaft.

With reference to FIG. 13, there is shown a rotary cartridge seal 200 in accordance with the present invention which generally includes a cold flowable plastic ring 202 having a body 204 which provides a means for sealably engaging a housing 206 bore 208 and a lip 210 which provides a means for sealably engaging a shaft 212. A spring 220, disposed between the body 204 and the lip 210, provides a means for biasing the lip 210 against the shaft 212.

A separable composite retainer 222 is provided for fixing the plastic ring 202 within the housing bore 208 and around the shaft 212. The retainer 222 includes a surface of revolution with a rear portion 224 having a radius suitable for press fitting into the housing bore 208 and a front portion 226 of lesser radius ending in a ring 228. Thus, the locking ring-retainer 222, in addition to retaining the seal assembly 200 in the housing 206, also retains the spring energizer 220 within the confines of the seal assembly 200. Between the rear portion 224 and the ring 228 is a spring portion 232 which provides a means for controlling the residual stress in a radial direction within the plastic ring 202 and preventing shrinkage of the plastic ring 202, particularly the body portion 208 toward the shaft 212.

As shown in FIG. 13, clearances 236 and 238 are provided between the ring 228 and the body portion 204 to facilitate assembly of the seal 200. A thin area indicated at 240 of the spring portion 232 of the retainer 222 is utilized to control the spring force of the retainer 222 against the body portion 204. Accordingly, pressure is applied to the body portion 204 at a surface 244.

In addition, because the retainer 222 is flexible through the spring portion 232, the force necessary to assemble the seal 220 between the housing 206 and shaft 212 is significantly reduced. By varying the radial wall thickness of the plastic ring 202 and thickness of the spring portion 232, the seal can be tailored for use in a wide environment of pressures and temperatures.

The embodiment 200 further differs from the hereinabove discussed embodiment 10 in that a step 250 inwardly depending from the rear portion 224 of the retainer 222 facilitates removal of the seal 200 from engagement with the housing 206 and shaft 212. A thickness indicated at 252 of the step 250 provides support for the spring portion 232 and accordingly provides a means for controlling the force needed to press fit the retainer 222 into the housing bore 208.

With reference to FIG. 14, there is shown yet another embodiment 260 in accordance with the present invention, common character references indicating identical or substantially the same structural components as shown in FIG. 13. In this embodiment the retainer 262 includes a widened ring portion 264 as referenced by the arrows 266.

In addition a rear portion 268 of the retainer 262 includes a thin flange 270 for engaging the housing bore 208 and an inwardly depending flange 272 which provides a means for both holding the spring 220 between the body 204 and lip 210 of the plastic ring 202 and for facilitating removal of the seal 260 from engagement with the housing bore 208 and shaft 212.

The thin flange 270 reduces assembly force and can be of various thicknesses to vary the assembly force. This embodiment reduces the mass around the composite loading portion 268 of the retainer 262 in order to increase flexibility. This is especially important in small diameters.

A further embodiment 280 of the present invention is shown in FIG. 15 in which the retainer 282 includes a relatively thick body 284 and the plastic ring 286 includes an inwardly extending lip 288 which maintains the spring 220 within the seal 280. This embodiment is particularly useful for large diameter shafts.

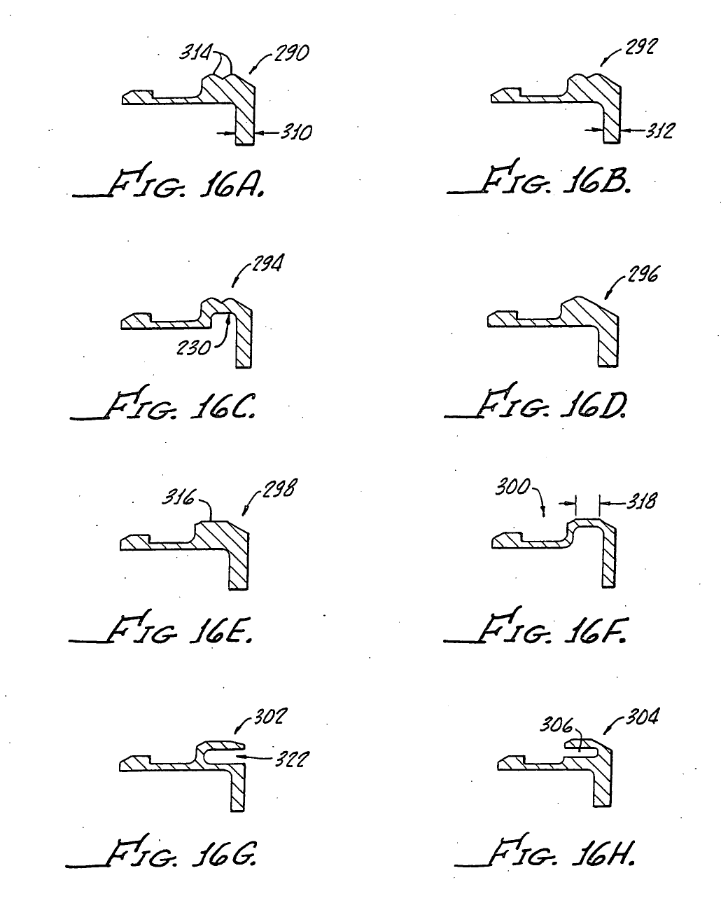

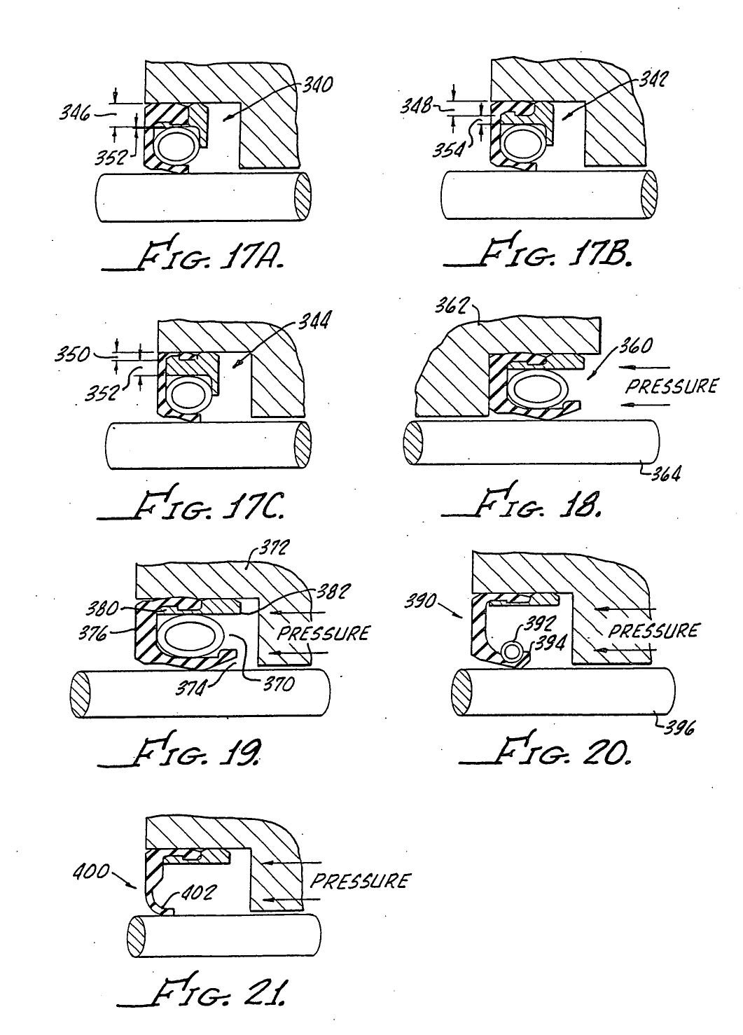

FIGS. 16A-16H shows various non-metallic retainer rings 290, 292, 294, 296, 298, 300, 302, 304, which provide various forces and sealing capabilities. As earlier indicated and with reference to FIGS. 16A and 16B, a wall thicknesses 310, 312 controls the force required to assemble the seal. Various seals can be provided also to reduce the force required to assemble the seal 290 into a bore, not shown in FIG. 16A-16G. Particularly, the plurality of load rings 314 reduce surface contact as opposed to a flat surface 316 shown in FIG. 16E. It should be appreciated, however, that the flat areas as indicated by the arrows 318 do provide seal stability after assembly.

As shown in FIG. 16C, the retainer 294 may be undercut 320 in order to reduce the mass of the retainer 294 while also reducing the force required for assembly. The undercut 320 may be radial, or, as shown in FIG. 16G, the undercut 322, may be axial.

In FIG. 16H the retainer 304 has been modified to provide a circular undercut 306, similar to the retainer 302 shown in FIG. 16G, in order to create greater retainer flexibility for facilitating assembly of the retainer 304 with a plastic ring, not shown, into a housing, also not shown in FIG. 16H.

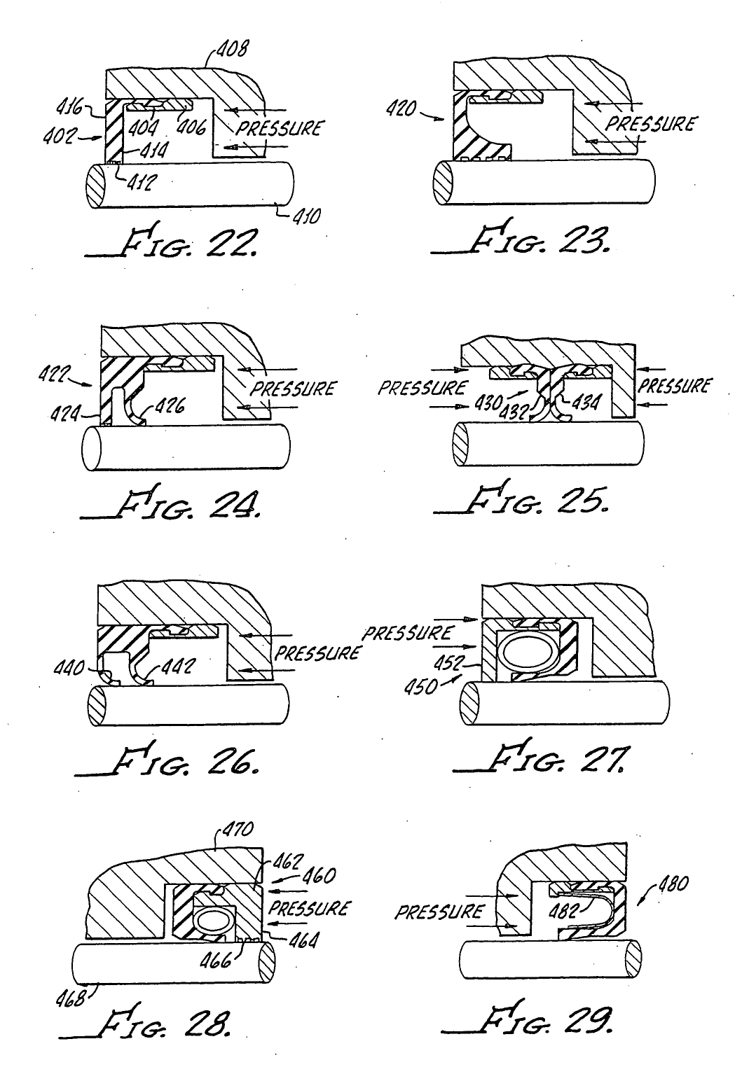

Variations and combinations of plastic ring body thickness and spring portion thickness of the retainer are shown in FIGS. 17A, 17B, 17C. Each of these seals 340, 342, 343, 344 show various thicknesses of the plastic body as indicated by the arrows 346, 348, 350 and spring portion as indicated by the arrows 354, 356. In FIG. 17A, the thick outside wall 346, in combination with a thin spring portion 352, causes high shrinkage of the plastic when subjected to elevated temperatures. FIG. 17B shows a comprising wall thickness of the spring portion 354 and plastic band 348, whereby a certain degree of shrinkage will occur on the plastic rings. However, no defamation will occur on the spring portion 354 due to greater thickness. FIG. 17C shows the embodiment 344 with a thin plastic body 350 and a thickened spring portion 356. These variations are shown in order to provide an understanding of the control of radial stress in the plastic portions 346, 348, 350 through the use of a spring portion in the retainer.

FIG. 18 illustrates a seal 360 utilized as a captivated sealed gland. This type of design can be used in relatively high pressures because, upon application, the pressure, the housing 362 absorbs the pressure force. The assembly force in this type of design should be just enough to prevent the seal 360 from rotating which is caused by a friction developed between the seal 360 and the shaft 364. A minimum amount of force is required which is desirable since damage to the seal is minimized during assembly. The force required to assemble the seal 360 into the housing 362 will depend upon the seal diameter and seal cross-section and the reverse pressure acting on the back portion of the seal.

More particularly the insertion force and retention is affective by the following parameters:
1. Modulus of elasticity of the composite retaining ring.
2. The radial cross section of the composite retaining ring.
3. The axial area of contact between the composite retaining ring and the metal housing.
4. Interference between the composite retaining ring and the housing.

The effect of the material modulus of elasticity, stainless steel, commonly heretofore used as a retaining ring with cartridge seals, has a modulus of elasticity of 29,000,000 lb/in². This modulus of elasticity to a large extent determines the force required to assemble and retain the seal in the housing. For some applications, it is desirable to reduce this insertion force for ease of insertion and to minimize the risk of damage when the seal is replaced.

The composite locking ring must have a modulus of elasticity at least double that of the seal material for proper retention of the seal and to prevent the seal material from shrinking towards the shaft. For example, a high performance polymer such as PEEK could be used that has a modulus of elasticity of about 500,000 lb-inch in conjunction with a composite material consisting of PEEK filled with carbon fiber to attain a modulus of elasticity of approximately 1,000,000 lb-inches. The seal material with the lower modulus of elasticity will be more flexible for greater sealing capability while the higher modulus of elasticity locking ring will retain the seal and prevent it from shrinking towards the shaft and retain the seal assembly into the housing.

It is also very desirable to use a composite material for the locking ring that maintains a constant or nearly constant modulus of elasticity over the operational temperature range. For lower cost fabrication as compared to a material such as stainless steel, the material must be capable of being molded or easily machined.

The retention force is proportional to the modulus of elasticity of the retaining ring. Therefore, the force can be controlled within certain limits by adjusting the proportions and type of the composite used to fabricate the retaining ring.

Any material that has this property and can be molded could be used for the retaining locking ring. The material must have a modulus of elasticity that is higher than the modulus of elasticity of the seal, while a seal material that is cold flowable, such as PTFE, filled PTFE, UHMW and filled UHMW is desirable for sealing ability, through cold flow properties is not a requirement.

Rotary seals are subject to temperature variations. In many applications, seals need to be sterilized in an autoclave. Sterilization generally occurs at a minimum temperature of 275° F. for some time period between 15 minutes and 1 hour. In the actual application, heat is generated by the friction developed at the point of contact between the shaft and the seal, thus increasing the temperature of the seal. Therefore, in selecting the composite material, it is necessary to take into consideration the variation of the modulus of elasticity as a function of temperature.

The greater the radial cross-section, the greater the force required to assemble and retain the locking ring into the housing. The force required to assemble and retain the seal into the housing can be calculated from Roark's hoop stress analysis. Composite materials, such as PEEK with 30% carbon fiber filled, have a modulus of elasticity that is adequate to produce suitable forces for retaining the seal assembly.

The greater the axial area of contact between the housing and retaining ring, the greater the assembly force required and the greater the retaining force.

The greater the interference between two units, the greater the force retaining ring into the housing. However, the interference force is determined by the modulus of elasticity in compression, which must be considered in the design so you do not cause the material failure.

Selection of Materials

The selection of appropriate composite material depends on the application and usage. Some composite materials, like PEEK or filled PEEK, can be injection molded to reduce the cost of fabrication of parts. Tests were conducted to determine the retention force that occurs after the composite retaining ring has been subjected to elevated temperatures to sterilization temperature range for one hour. Test results show that during the first period, the reduction in force was 7%. Thereafter, repeated autoclave at 275° F. for an hour, retaining force remains relatively constant with a decrease of approximately 1% to 0.05%, per autoclave cycle, indicating that this material provides retention force for the specific temperature range.

FIG. 19 shows a seal 370 utilized as an uncaptivated seal gland. In this instance, the force required to assemble the seal 370 will depend primarily on the fluid pressure, acting on the seal plus safety factor. The larger the cross section of the seal, the greater the force that will be acting on the seal due to the fluid pressure trying to disassemble such seals from the housing 372. In this instance, the assembly force should be directly related to the force derived by the pressure acting on the seal 372. In the uncaptivated groove 374, the variation assembly force should be minimum so as to minimize damage to the seal 372 during assembly as the assembly force is applied directly onto the plastic ring 376 and if excessive force is applied, it may cause damage to the ring 376. In this instance, it is desirable to increase the area of contact between the plastic ring 376 and the ring 380 of the non-metallic retainer 382, such as illustrated in FIG. 14.

FIG. 20 shows an alternative embodiment 390 of the present invention in which a garter type spring 392 is utilized for biasing a lip 394 against a shaft 396.

FIG. 21 shows yet another embodiment 400 in accordance with the present invention which utilizes a lip 402 as hereinabove discussed in connection with FIG. 1.

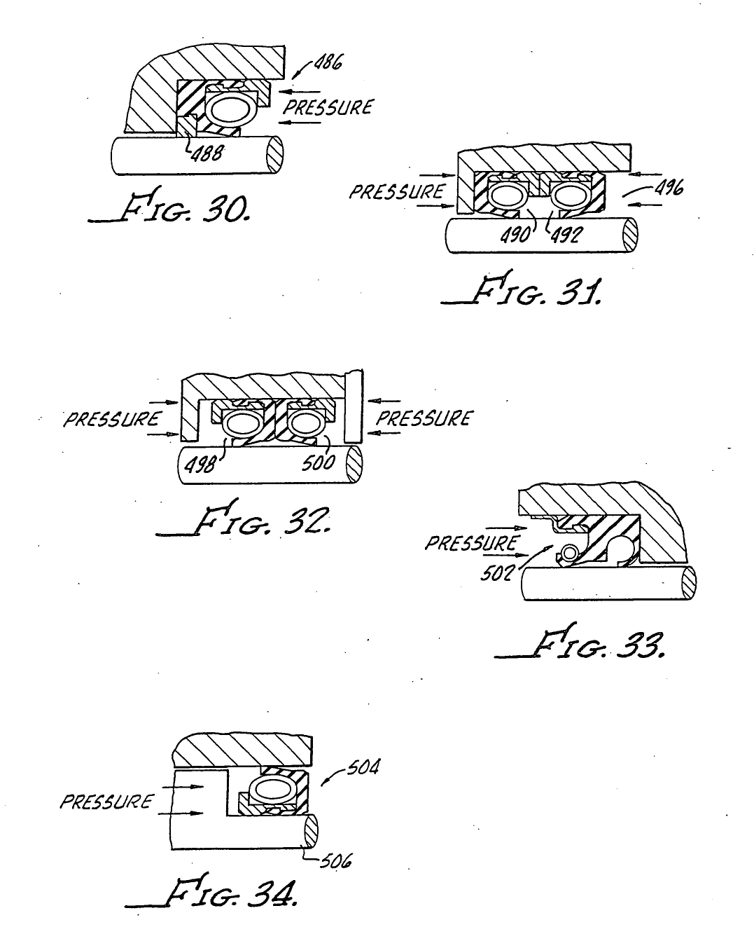

FIG. 22 illustrates a seal 402 utilizing the principles of the spring portion 404 of a retainer 406 as a clearance seal design primarily for keeping dust and dirt from entering between the housing 408 and shaft 410. In this instance, grooves 412 in an end 14 of the plastic ring 416 are utilized to provide minimum friction between the seal 402 and the shaft 410.

FIG. 23 shows a variation 20 of a clearance seal similar to that shown in FIG. 22.

FIG. 24 shows a combination seal 422 utilizing both a clearance seal 424 and a lip seal 426.

FIG. 25 shows yet another embodiment of the present invention wherein two seals 432, 434 are utilized back to back.

FIG. 26 is yet another embodiment of the present invention in which two lips 440, 442 are used.

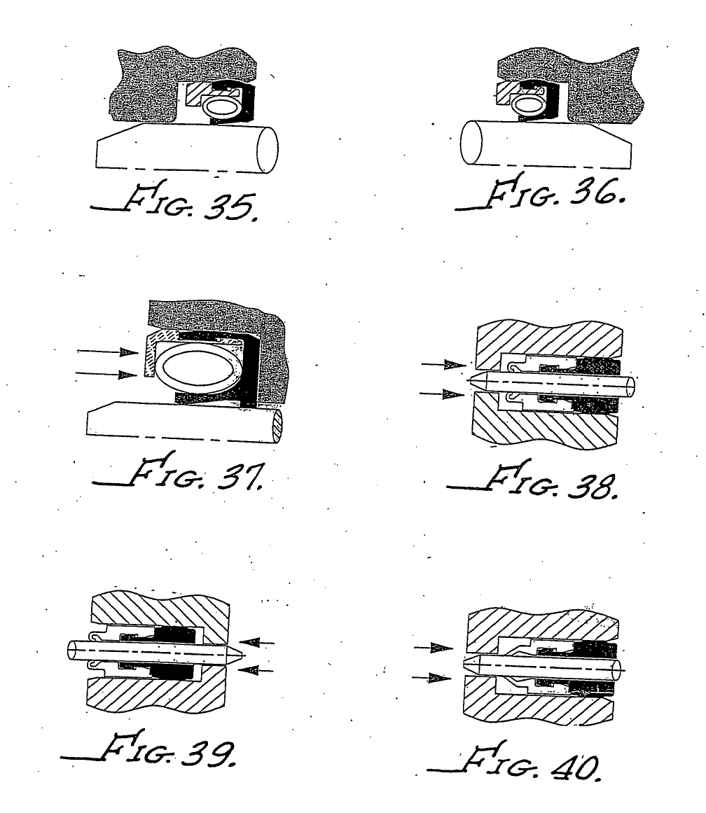

FIG. 27 shows an embodiment 450 of the present invention similar to that shown in FIG. 13 but with a larger non-metallic retainer step portion 452.

FIG. 28 shows another embodiment 460 of the present invention in which the composite retainer 462 includes a step portion 464 having grooves 466 for providing a labyrinth seal with a shaft 468. In this instance, it is preferable that the retainer 462 is formed out of a bearing composite material to provide sufficient force to retain the seal and the housing 470 and not damage the shaft 468.

FIG. 29 shows another embodiment 480 of the present invention utilizing a V-type spring 482.

FIG. 30 shows yet another embodiment 486 of the present invention utilizing a back-up ring 488.

FIG. 31 illustrates two seals 490, 492 disposed in a cavity 496 for use in relatively low pressures.

FIG. 32 shows a variation of the design shown in FIG. 31 in which the seals 498, 500 are disposed back to back.

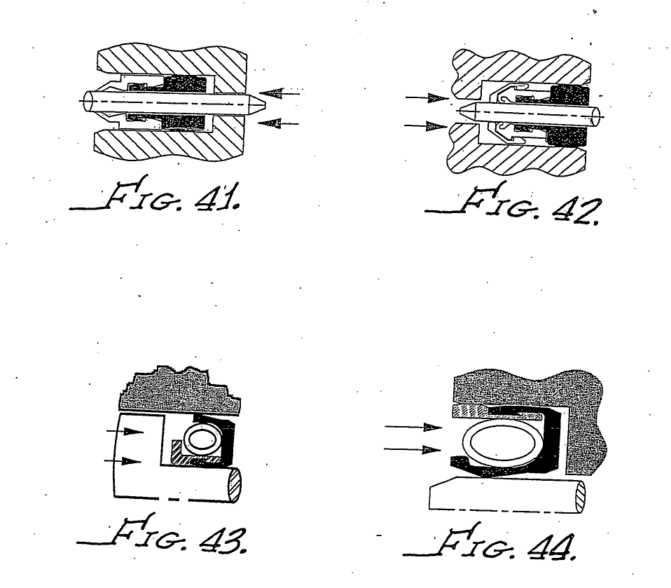

FIG. 33 shows another seal 502 using various combinations of the features hereinabove discussed.

FIG. 34 shows yet another embodiment of the present invention 504 in which the seal 504 is mounted in the shaft 506.

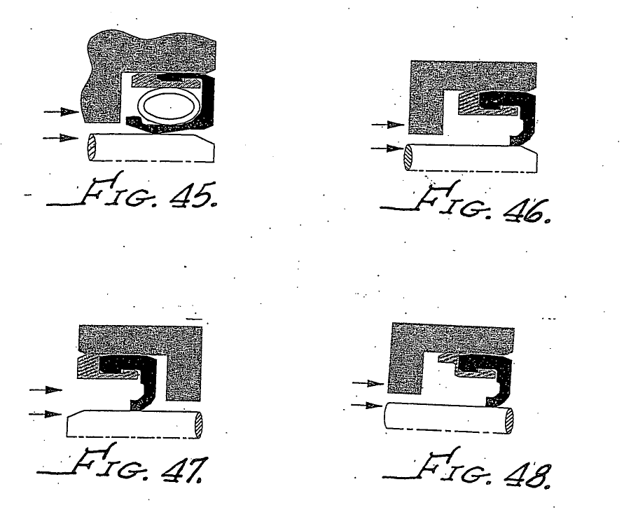

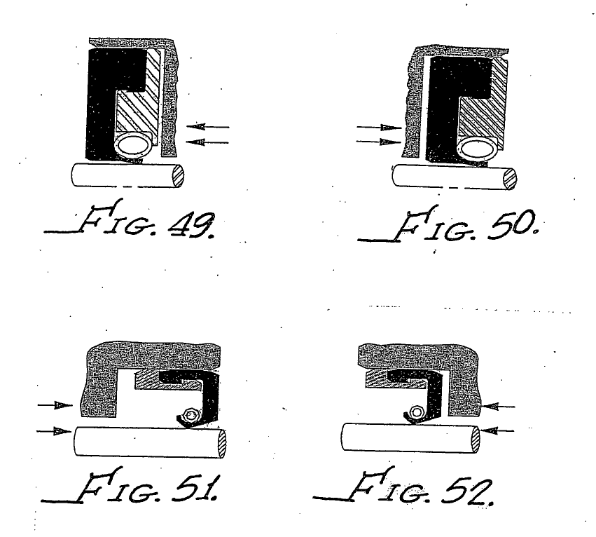

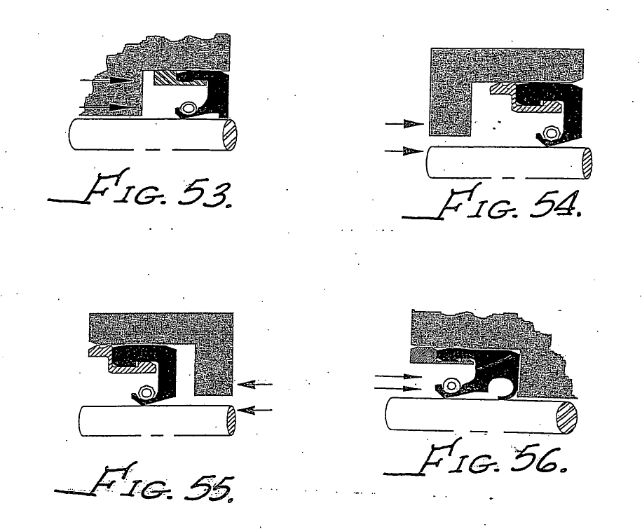

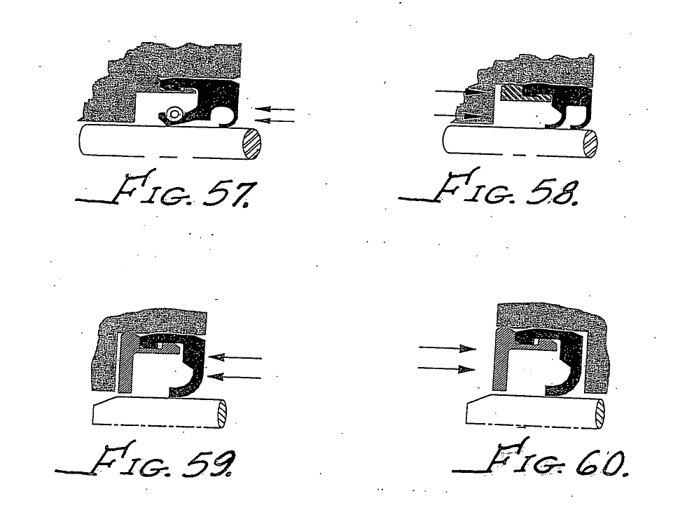

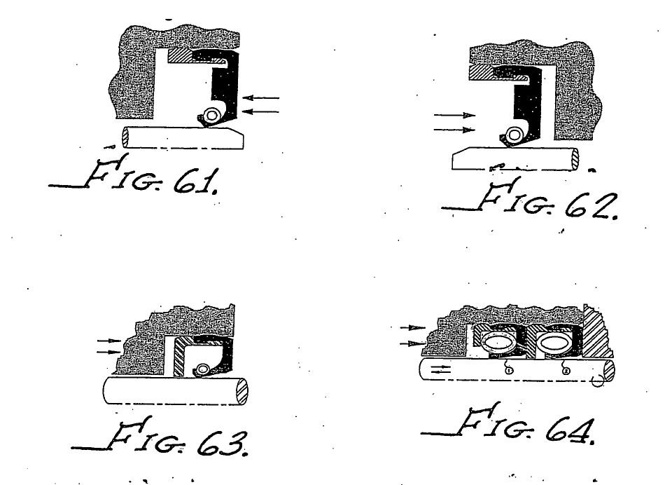

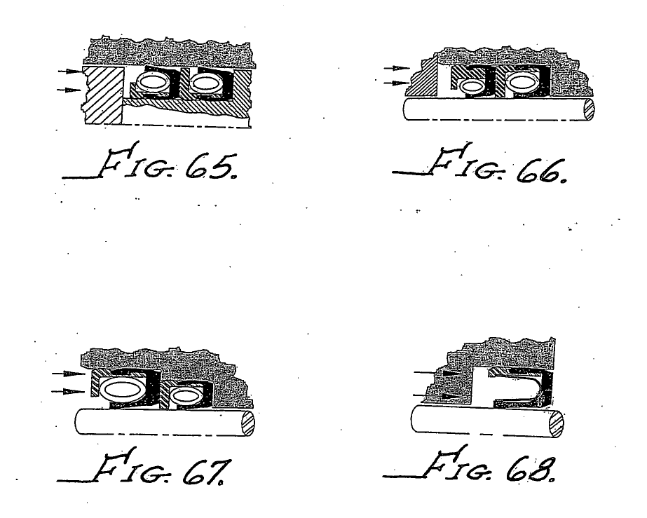

FIGS. 35-68 show additional embodiments. Reference numerals have been omitted in FIGS. 35-68 for the sake of brevity. Elements of each embodiment may be identified with similar element set forth and described in FIGS. 1-34.

Although there has been hereinabove described specific rotary cartridge seals with composite retainers in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. In a rotary seal cartridge having a plastic sealing ring with a body for sealably engaging a housing bore and a lip for sealably engaging a shaft rotatable within said housing bore and an internal groove in said body for engaging the ring in order to latch the plastic ring and a retainer together with residual stress in both the axial and radial direction within the plastic ring due to the groove and ring dimensions and shape, an improvement wherein said retainer comprises:
a composite retainer for fixing the plastic ring within said housing and bore and around the shaft, said composite having a surface of revolution with a rear portion having a radius suitable for press fitting into said housing bore and a front portion of lesser radius ending in a ring, said retainer being formed from a composite material having a modulus of elasticity at least double that of a sealing ring material in order to reduce the insertion force of the cartridge yet maintain a retention force sufficient to prevent seal separation from the housing upon application of temperature and pressure differentials.

2. The cartridge seal according to claim 1 wherein said composite material comprises polyetherether ketone.

3. The cartridge seal according to claim 1 wherein said composite material comprises filled polyetherether ketone to increase the modulus of elasticity.

4. The cartridge seal according to claim 1 wherein the plastic ring and said composite retainer have similar coefficients of expansion.

5. The cartridge seal according to claim 1 with a composite retainer that can be machined or molded.
